(19) United States
(12) Patent Application Publication
(10) Pub. No.: US 2023/0041808 A1
(43) Pub. Date: Feb. 9, 2023

(54) RESIDUAL PROCESSING FOR VIDEO ENCODING AND DECODING

(71) Applicant: InterDigital VC Holdings France, SAS, Cesson Sevigne (FR)

(72) Inventors: Ya Chen, Rennes (FR); Fabrice Le Leannec, Betton (FR); Franck Galpin, Thorigne-Fouillard (FR); Tangi Poirier, Thorigné-Fouillard (FR)

(73) Assignee: InterDigital VC Holdings France, SAS, Cesson Sevigne (FR)

(21) Appl. No.: 17/787,815

(22) PCT Filed: Dec. 16, 2020
(86) PCT No.: PCT/EP2020/086357

§ 371 Date: Jun. 21, 2022

(30) Foreign Application Priority Data
Dec. 23, 2019 (EP) 19306755.0

(51) Int. Cl. H04N 19/60; H04N 19/176; H04N 19/44; H04N 19/18; H04N 19/186

(52) U.S. Cl. CPC H04N 19/60; H04N 19/176; H04N 19/44; H04N 19/18; H04N 19/186

(57) ABSTRACT

A method, apparatus or system for processing video information can involve determining at least one Rice parameter associated with a transform residual coding process applied during encoding of a block of picture information, wherein the Rice parameter is a fixed value, or is determined based on, for example, a frequency region or a coefficient scanning position for the transform residual coding, or a number of neighbors of the block of picture information, and encoding or decoding the block of picture information based on the at least one Rice parameter.

### TECHNICAL FIELD

The present disclosure involves video compression.

### BACKGROUND

To achieve high compression efficiency, image and video coding schemes usually employ prediction and transform to leverage spatial and temporal redundancy in the video content. Generally, intra or inter prediction is used to exploit the intra or inter frame correlation, then the differences between the original picture block and the predicted picture block, often denoted as prediction errors or prediction residuals, are transformed, quantized and entropy coded. To reconstruct the video, the compressed data is decoded by inverse processes corresponding to the prediction, transform, quantization and entropy coding.

One example of an approach to video coding is that provided by High Efficiency Video Coding (HEVC). More recent additions to video compression technology include various versions of the reference software and/or documentation known as the Joint Exploration Model (JEM) being developed by the Joint Video Exploration Team (JVET) as part of development of a new video coding standard known as Versatile Video Coding (VVC). The aim of JEM is to make further improvements to the existing HEVC (High Efficiency Video Coding) standard, e.g., increased coding efficiency, decreased complexity, etc.

### SUMMARY

In general, at least one example of an embodiment can involve a method comprising: determining a fixed binary codeword corresponding to at least one Rice parameter associated with a transform residual coding process applied during coding of a block of picture information; and decoding the block of picture information based on the fixed binary codeword.

In general, at least one example of an embodiment can involve apparatus comprising: one or more processors configured to determine a fixed binary codeword corresponding to at least one Rice parameter associated with a transform residual coding process applied during coding of a block of picture information; and decode the block of picture information based on the fixed binary codeword.

In general, at least one example of an embodiment can involve a method comprising:

determining a fixed binary codeword corresponding to at least one Rice parameter associated with a transform residual coding process; and encoding a block of picture information based on the fixed binary codeword.

In general, at least one example of an embodiment can involve apparatus comprising: one or more processors configured to determine a fixed binary codeword corresponding to at least one Rice parameter associated with a transform residual coding process; and encode a block of picture information based on the fixed binary codeword.

In general, at least one example of an embodiment can involve a method comprising: determining at least one Rice parameter associated with a transform residual coding process applied during coding of a block of picture information, wherein the at least one Rice parameter is determined based on at least one frequency region or a coefficient scanning position for the transform residual coding; and decoding the block of picture information based on the at least one Rice parameter.

In general, at least one example of an embodiment can involve apparatus comprising: one or more processors configured to determine at least one Rice parameter associated with a transform residual coding process applied during coding of a block of picture information, wherein the at least one Rice parameter is determined based on at least one frequency region or a coefficient scanning position for the transform residual coding; and decode the block of picture information based on the at least one Rice parameter.

In general, at least one example of an embodiment can involve a method comprising: determining at least one Rice parameter associated with a transform residual coding process, wherein the at least one Rice parameter is determined based on at least one frequency region or a coefficient scanning position for the transform residual coding; and encoding a block of picture information based on the at least one Rice parameter.

In general, at least one example of an embodiment can involve apparatus comprising: one or more processors configured to determine at least one Rice parameter associated with a transform residual coding process, wherein the at least one Rice parameter is determined based on at least one frequency region or a coefficient scanning position for the transform residual coding; and encode a block of picture information based on the at least one Rice parameter.

In general, at least one example of an embodiment can involve a method comprising: determining at least one Rice parameter associated with a transform residual coding process applied during coding of a block of picture information, wherein the at least one Rice parameter is determined based on a number of neighbors of the block of picture information less than five; and decoding the block of picture information based on the at least one Rice parameter.

In general, at least one example of an embodiment can involve apparatus comprising: one or more processors configured to determine at least one Rice parameter associated with a transform residual coding process applied during coding of a block of picture information, wherein the at least one Rice parameter is determined based on a number of neighbors of the block of picture information less than five; and decode the block of picture information based on the at least one Rice parameter.

In general, at least one example of an embodiment can involve a method comprising: determining at least one Rice parameter associated with a transform residual coding process, wherein the at least one Rice parameter is determined based on a number of neighbors of the block of picture information less than five; and encoding the block of picture information based on the at least one Rice parameter.

In general, at least one example of an embodiment can involve apparatus comprising: one or more processors configured to determine at least one Rice parameter associated with a transform residual coding process, wherein the at least one Rice parameter is determined based on a number of neighbors of the block of picture information less than five; and encode the block of picture information based on the at least one Rice parameter.

In general, at least one example of an embodiment can involve method comprising: determining at least one Rice parameter associated with a transform residual coding process applied during coding of a block of picture information, wherein determining the at least one Rice parameter is based on one of: determining a fixed binary codeword corresponding to the at least one Rice parameter; or at least one frequency region or a coefficient scanning position for the transform residual coding; or a number of neighbors of the block of picture information less than five; and decoding the block of picture information based on the at least one Rice parameter.

In general, at least one example of an embodiment can involve apparatus comprising: one or more processors configured to determine at least one Rice parameter associated with a transform residual coding process applied during coding of a block of picture information, wherein determining the at least one Rice parameter is based on one of: determining a fixed binary codeword corresponding to the at least one Rice parameter; or at least one frequency region or a coefficient scanning position for the transform residual coding; or a number of neighbors of the block of picture information less than five; and decode the block of picture information based on the at least one Rice parameter.

In general, at least one example of an embodiment can involve a method comprising: determining at least one Rice parameter associated with a transform residual coding process, wherein determining the at least one Rice parameter is based on one of: determining a fixed binary codeword corresponding to the at least one Rice parameter; or at least one frequency region or a coefficient scanning position for the transform residual coding; or a number of neighbors of the block of picture information less than five; and encoding the block of picture information based on the at least one Rice parameter.

In general, at least one example of an embodiment can involve apparatus comprising: one or more processors configured to determine at least one Rice parameter associated with a transform residual coding process, wherein determining the at least one Rice parameter is based on one of: determining a fixed binary codeword corresponding to the at least one Rice parameter; or at least one frequency region or a coefficient scanning position for the transform residual coding; or a number of neighbors of the block of picture information less than five; and encode the block of picture information based on the at least one Rice parameter.

In general, another example of an embodiment can involve a bitstream or signal formatted to include syntax elements and picture information, wherein the syntax elements are produced and the picture information is encoded by processing based on any one or more of the examples of embodiments of methods in accordance with the present disclosure.

In general, one or more other examples of embodiments can also provide a computer readable storage medium, e.g., a non-volatile computer readable storage medium, having stored thereon instructions for encoding or decoding picture information such as video data according to the methods or the apparatus described herein. One or more embodiments can also provide a computer readable storage medium having stored thereon a bitstream generated according to methods or apparatus described herein. One or more embodiments can also provide methods and apparatus for transmitting or receiving a bitstream or signal generated according to methods or apparatus described herein.

The above presents a simplified summary of the subject matter in order to provide a basic understanding of some aspects of the present disclosure. This summary is not an extensive overview of the subject matter. It is not intended to identify key/critical elements of the embodiments or to delineate the scope of the subject matter. Its sole purpose is to present some concepts of the subject matter in a simplified form as a prelude to the more detailed description provided below.

### BRIEF DESCRIPTION OF THE DRAWING

The present disclosure may be better understood by consideration of the detailed description below in conjunction with the accompanying figures in which:

FIG. 1 illustrates, in the form of a block diagram, an example of an embodiment of an encoder, e.g., video encoder, suitable for implementing various aspects, features and embodiments described herein;

FIG. 2 illustrates, in the form of a block diagram, an example of an embodiment of a decoder, e.g., video decoder, suitable for implementing various aspects, features and embodiments described herein;

FIG. 3 illustrates division of a Coding Tree Unit (CTU) in HEVC into Coding Units (CU), Prediction Units (PU) and Transform Units (TU);

FIG. 4 illustrates an example of a residual coding structure for transform blocks;

FIG. 5 illustrates an example of a residual coding structure for transform skip blocks;

FIG. 6 shows an example of a local neighbor template used for Rice parameter derivation;

FIG. 7 shows another example of a local neighbor template used for Rice parameter derivation in accordance with an example of at least one embodiment;

FIG. 8 illustrates an example of a transform block (TB) being split into a plurality of frequency regions in accordance with an example of at least one embodiment;

FIG. 9 illustrates, in block diagram form, an example of an embodiment of apparatus or a device or a system suitable for implementing one or more aspects or features of the present disclosure;

FIG. 10 illustrates, in flow diagram form, an example of at least one embodiment;

FIG. 11 illustrates, in flow diagram form, an example of at least one embodiment; and

FIG. 12 through 14 illustrate, in flow diagram form, various examples of other embodiments.

It should be understood that the drawings are for purposes of illustrating examples of various aspects, features and embodiments in accordance with the present disclosure and are not necessarily the only possible configurations. Throughout the various figures, like reference designators refer to the same or similar features.

### DETAILED DESCRIPTION

For ease of explanation, one or more aspects and/or examples of embodiments and/or examples of features described herein may be described in the context of a particular standard such as VVC. However, reference to VVC or any other particular standard is not intended to limit, and does not limit, the scope of potential application of the various embodiments and features described herein.

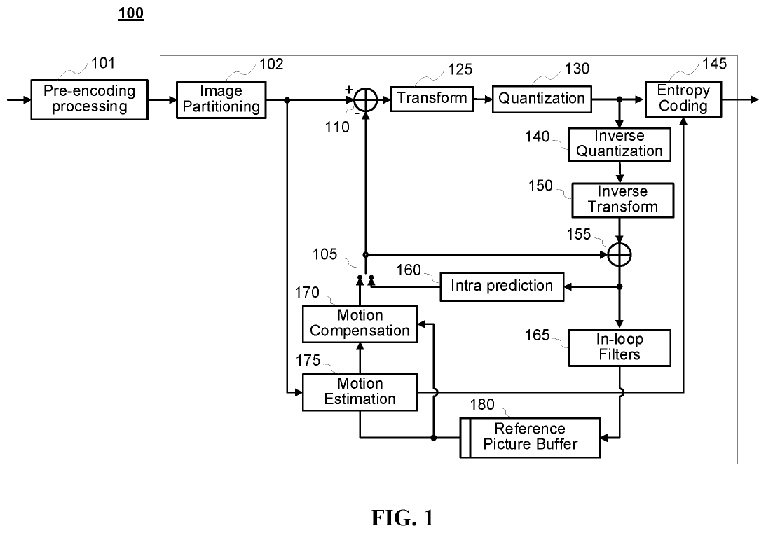

Turning now to the figures, FIG. 1 illustrates an example of a video encoder 100, such as a High Efficiency Video Coding (HEVC) encoder. Variations of this encoder 100 are contemplated. However, for clarity, the encoder 100 is described below without describing all expected variations. For example, FIG. 1 may also illustrate an encoder in which improvements are made to the HEVC standard or an encoder employing technologies similar to HEVC, such as a JEM (Joint Exploration Model) encoder under development by JVET (Joint Video Exploration Team) as part of development of a new video coding standard known as Versatile Video Coding (VVC).

Before being encoded, the video sequence may go through pre-encoding processing (101), for example, applying a color transform to the input color picture (e.g., conversion from RGB 4:4:4 to YCbCr 4:2:0), or performing a remapping of the input picture components in order to get a signal distribution more resilient to compression (for instance using a histogram equalization of one of the color components). Metadata can be associated with the pre-processing and attached to the bitstream.

In HEVC, to encode a video sequence with one or more pictures, a picture is partitioned (102) into one or more slices where each slice can include one or more slice segments. A slice segment is organized into coding units, prediction units, and transform units. The HEVC specification distinguishes between “blocks” and “units,” where a “block” addresses a specific area in a sample array (e.g., luma, Y), and the “unit” includes the collocated blocks of all encoded color components (Y, Cb, Cr, or monochrome), syntax elements, and prediction data that are associated with the blocks (e.g., motion vectors).

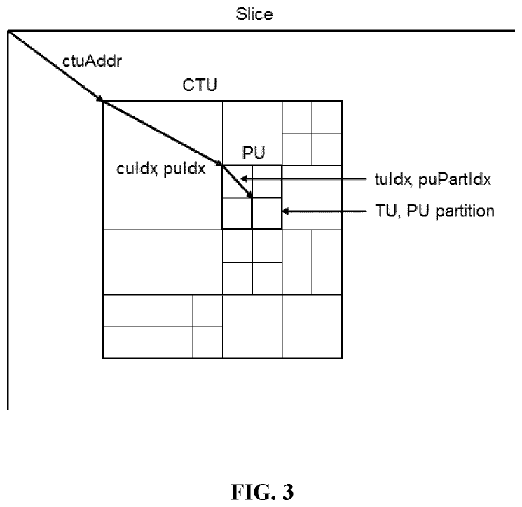

For coding in HEVC, a picture is partitioned into coding tree blocks (CTB) of square shape with a configurable size, and a consecutive set of coding tree blocks is grouped into a slice. A Coding Tree Unit (CTU) contains the CTBs of the encoded color components. A CTB is the root of a quadtree partitioning into Coding Blocks (CB), and a Coding Block may be partitioned into one or more Prediction Blocks (PB) and forms the root of a quadtree partitioning into Transform Blocks (TBs). Corresponding to the Coding Block, Prediction Block, and Transform Block, a Coding Unit (CU) includes the Prediction Units (PUs) and the tree-structured set of Transform Units (TUs), a PU includes the prediction information for all color components, and a TU includes residual coding syntax structure for each color component. The size of a CB, PB, and TB of the luma component applies to the corresponding CU, PU, and TU. An illustration of division of a Coding Tree Unit (CTU) in HEVC into Coding Units (CU), Prediction Units (PU) and Transform Units (TU) is shown in FIG. 3.

In JEM, the QTBT (Quadtree plus Binary Tree) structure removes the concept of multiple partition types in HEVC, i.e., removes the separation of CU, PU and TU concepts. A Coding Tree Unit (CTU) is first partitioned by a quadtree structure. The quadtree leaf nodes are further partitioned by a binary tree structure. The binary tree leaf node is named as Coding Units (CUs), which is used for prediction and transform without further partitioning. Thus, the CU, PU and TU have the same block size in the new coding QTBT block structure. In JEM, a CU consists of Coding Blocks (CBs) of different color components.

In the present application, the term “block” can be used to refer, for example, to any of CTU, CU, PU, TU, CB, PB, and TB. In addition, the “block” can also be used to refer to a macroblock and a partition as specified in H.264/AVC or other video coding standards, and more generally to refer to an array of data of various sizes.

In the encoder 100, a picture is encoded by the encoder elements as described below. The picture to be encoded is partitioned (102) and processed in units of, for example, CUs. Each unit is encoded using, for example, either an intra or inter mode. When a unit is encoded in an intra mode, it performs intra prediction (160). In an inter mode, motion estimation (175) and compensation (170) are performed. The encoder decides (105) which one of the intra mode or inter mode to use for encoding the unit, and indicates the intra/inter decision by, for example, a prediction mode flag. Prediction residuals are calculated, for example, by subtracting (110) the predicted block from the original image block.

The prediction residuals are then transformed (125) and quantized (130). The quantized transform coefficients, as well as motion vectors and other syntax elements, are entropy coded (145) to output a bitstream. The encoder can skip the transform and apply quantization directly to the non-transformed residual signal. The encoder can bypass both transform and quantization, i.e., the residual is coded directly without the application of the transform or quantization processes.

The encoder decodes an encoded block to provide a reference for further predictions. The quantized transform coefficients are de-quantized (140) and inverse transformed (150) to decode prediction residuals. Combining (155) the decoded prediction residuals and the predicted block, an image block is reconstructed. In-loop filters (165) are applied to the reconstructed picture to perform, for example, deblocking/SAO (Sample Adaptive Offset) filtering to reduce encoding artifacts. The filtered image is stored at a reference picture buffer (180).

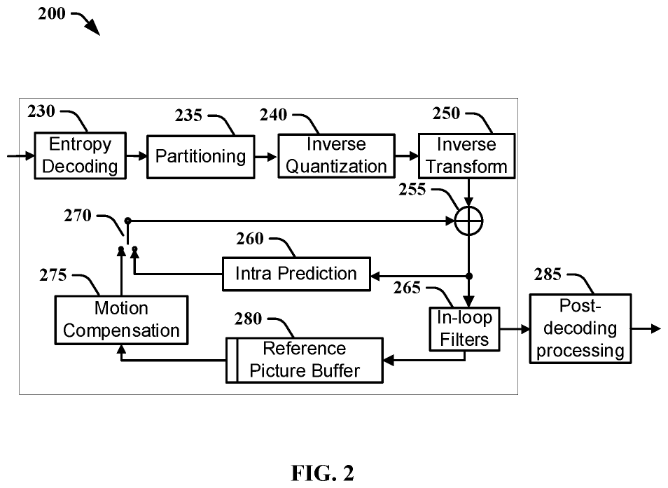

FIG. 2 illustrates a block diagram of a video decoder 200. In the decoder 200, a bitstream is decoded by the decoder elements as described below. Video decoder 200 generally performs a decoding pass reciprocal to the encoding pass as described in FIG. 1. The encoder 100 also generally performs video decoding as part of encoding video data.

In particular, the input of the decoder includes a video bitstream, which can be generated by video encoder 100. The bitstream is first entropy decoded (230) to obtain transform coefficients, motion vectors, and other coded information. The picture partition information indicates how the picture is partitioned. The decoder may therefore divide (235) the picture according to the decoded picture partitioning information. The transform coefficients are de-quantized (240) and inverse transformed (250) to decode the prediction residuals. Combining (255) the decoded prediction residuals and the predicted block, an image block is reconstructed. The predicted block can be obtained (270) from intra prediction (260) or motion-compensated prediction (i.e., inter prediction) (275). In-loop filters (265) are applied to the reconstructed image. The filtered image is stored at a reference picture buffer (280).

The decoded picture can further go through post-decoding processing (285), for example, an inverse color transform (e.g. conversion from YCbCr 4:2:0 to RGB 4:4:4) or an inverse remapping performing the inverse of the remapping process performed in the pre-encoding processing (101). The post-decoding processing can use metadata derived in the pre-encoding processing and signaled in the bitstream.

As discussed above, in the HEVC video compression standard, a picture is divided into so-called Coding Tree Units (CTU), and each CTU is represented by a Coding Unit (CU) in the compressed domain. Each CU is then given some Intra or Inter prediction parameters (Prediction Info). To do so, it is spatially partitioned into one or more Prediction Units (PUs), each PU being assigned some prediction information. The Intra or Inter coding mode is assigned on the CU level. An example of the described partitioning into CTU, CU and PU is shown in FIG. 3.

After the splitting or partitioning such as that shown in FIG. 3, intra or inter prediction is used to exploit the intra or inter frame correlation. Then the differences between the original block and the predicted block, often denoted as prediction errors or prediction residuals, are transformed, quantized, and entropy coded in Transform Blocks (TBs). To reconstruct the video, the compressed data are decoded by inverse processes corresponding to the entropy coding, quantization, transform, and prediction.

In general, at least one example of an embodiment can involve coefficient level coding. In HEVC, transform coefficients of a coding block are coded using non-overlapped coefficient groups (CGs or subblocks), and each CG contains the coefficients of a 4×4 block of a coding block. An example of another approach can involve the selection of coefficient group sizes becoming dependent upon TB size only, i.e., removing the dependency on channel type. As a consequence, various CGs (1×16, 2×8, 8×2, 2×4, 4×2 and 16×1) become available. The CGs inside a coding block, and the transform coefficients within a CG, are coded according to pre-defined scan orders.

Unlike HEVC where residual coding is designed for the statistics and signal characteristics of transform coefficient levels, an example of an alternative approach such as that mentioned in the preceding paragraph can employ two separate residual coding structures for transform coefficients and transform skip coefficients, respectively.

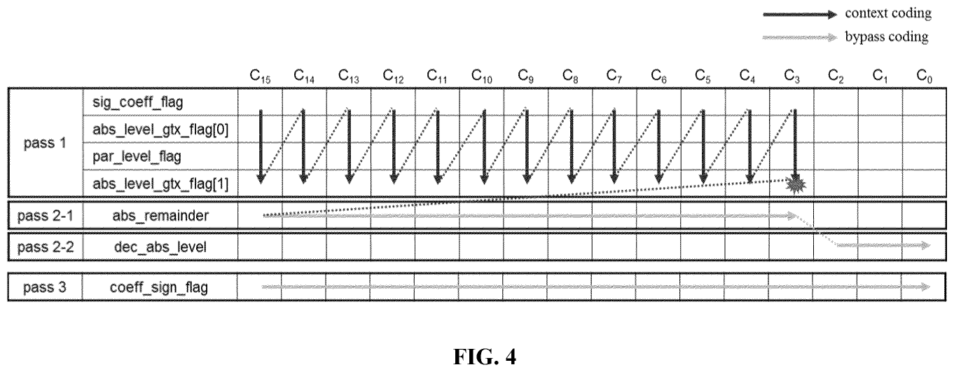

In general, at least one example of an embodiment can involve residual coding for transform coefficients. In an example of an approach to transform coefficient coding, a variable, e.g., designated “remBinsPass1”, is first set to the maximum number of context-coded bins (MCCB) and is decreased by one when a context-coded bin is signaled. While the remBinsPass1 is larger than or equal to four, the flags in the first coding pass, e.g., designated “sig_coeff_flag”, “abs_level_gtx_flag[0]” (greater than 1 flag), “par_flag”, and “abs_level_gtx_flag[1]” (greater than 3 flag), are coded by using context-coded bins. If the number of context coded bin is not greater than MCCB in the first pass coding, the other part of level information, which is indicated to be further coded in the first pass, is coded with a syntax element, e.g., designated “abs_remainder”, by using Golomb-Rice code and bypass-coded bins. When the remBinsPass1 becomes smaller than 4, the other coefficients which are not coded in the first pass are directly coded in the second pass with a syntax element, e.g., designated “dec_abs_level” by using Golomb-Rice code and bypass-coded bins. FIG. 4 illustrates an example of a residual coding structure for transform blocks. The remBinsPass1 is reset for every TB. The transition of using context-coded bins for the sig_coeff_flag, abs_level_gtx_flag[0], par_level_flag, and abs_level_gtx_flag[1] to using bypass-coded bins for the remaining syntax elements only happens at most once per TB. For a coefficient subblock, if the remBinsPass1 is smaller than 4, the entire coefficient subblock is coded by using bypass-coded bins. After all the above-mentioned level coding, the signs (coeff_sign_flag) for all scan positions with sig_coeff_flag equal to 1 is finally bypass coded.

In general, at least one example of an embodiment can involve residual coding for transform skip. In a manner similar to HEVC, an example of an approach such as that mentioned above may support a transform skip mode to be used for luma blocks of a size that may have an upper limit, e.g., indicated by a parameter designated “MaxTsSize”. That is, the maximum luma block size might be indicated as MaxTsSize by MaxTsSize, where the value of MaxTsSize is signaled in the picture parameter set (PPS) syntax and can be at most 32. In transform skip mode, the statistical characteristics of the signal are different from those of transform coefficients and applying transform to such residuals in order to achieve energy compaction around low-frequency components is generally less effective. Residuals with such characteristics are often found in screen content as opposed to natural camera captured content. The residual coding can be modified to account for the different signal characteristics of the (spatial) transform skip residual which includes:
the coefficient scanning: Forward scanning order is applied to scan the subblocks within a transform block and also the positions within a subblock;
no signaling of the last x/y position;
coded sub block flag coded for every subblock except for the DC subblock when all previous coded sub block flags are equal to 0;
sig_coeff_flag context modelling uses a reduced template, and context model of sig_coeff_flag depends on top and left neighboring values;
context model of abs_level_gtx_flag[0] also depends on top and left neighboring values;
par_level_flag and abs_level_gtx_flag[1] using only one context model respectively;
additional greater than 5, 7, 9 flags are signaled to indicate the coefficient level, one context for each flag;
modified Rice parameter derivation for the binarization of the remainder values;
sign flag coeff_sign_flag is context-coded, and context modeling for the sign flag is determined based on top and left neighboring coefficient values, and the sign flag is parsed after sig_coeff_flag to keep all context coded bins together.

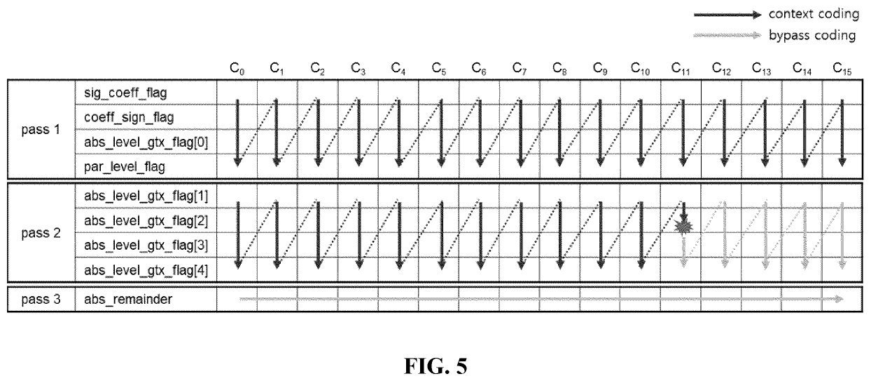

FIG. 5 illustrates an example of residual coding structure for transform skip blocks. In FIG. 5, syntax elements sig_coeff_flag, coeff_sign_flag, abs_level_gtx_flag[0], par_level_flag, are coded interleaved residual sample by residual sample in the first pass followed by abs_level_gtX_flag bitplanes, which are the second pass, and abs_remainder coding in the following third pass. That is:
First scan pass: significance flag (sig_coeff_flag), sign flag (coeff_sign_flag), absolute level greater than 1 flag (abs_level_gtx_flag[0]), and parity (par_level_flag) are coded. For a given scan position, if sig_coeff_flag is equal to 1, then coeff_sign_flag is coded, followed by the abs_level_gtx_flag[0] (which specifies whether the absolute level is greater than 1). If abs_level_gtx_flag[0] is equal to 1, then the par_level_flag is additionally coded to specify the parity of the absolute level.
Greater than x scan pass: for each scan position whose absolute level is greater than 1, up to four abs_level_gtx_flag[i] for i=1 . . . 4 are coded to indicate if the absolute level at the given position is greater than 3, 5, 7, or 9, respectively.
Remainder scan pass: the remainder of the absolute level are coded for all scan positions with abs_level_gtx_flag[4] equal to 1 (that is, the absolute level is greater than 9).
   The bins in scan passes #1 and #2 (the First scan pass and the Greater than x scan pass) are context coded until the MCCB in the TB have been exhausted. The bins in the last scan pass (the remainder scan pass) are bypass coded.

In general, at least one example of an embodiment can involve Rice parameter derivation for coefficient level coding. In an example of an approach such as that described above, abs_remainder is the remaining absolute value of a transform coefficient level that is coded with a code such as Golomb-Rice code and bypass-coded bins. Besides, dec_abs_level is an intermediate value of coefficient level that is also coded with Golomb-Rice code and bypass-coded bins.

In more detail with regard to Golomb-Rice code, Golomb codes are a family of systematic codes that can be adapted to the source statistics and are thereby well suited for coding applications. Golomb codes are generally constructed by a prefix and a suffix part. A Golomb-Rice code C_{grk} (V) of grade k is constructed by a unary coded prefix and k suffix bits. k indicates the number of least significant bins. An example is illustrated in Table 1 below for k=4. In Table 1 and the following description, x₀, x₁, . . . , xₙ, denote bits of the code word with xᵢ∈{0, 1}.

TABLE 1
Golomb-Rice code of order k = 4

| v | C_{gr4}(v) |
|---|---|
| 0-15 | 1 x₃, x₂, x₁, x₀ |
| 16-31 | 01 x₃, x₂, x₁, x₀ |
| 32-47 | 001 x₃, x₂, x₁, x₀ |
| . . . | . . . |

Let the code be used for unsigned integer values and the suffix be the k-bit binary representation of an integer 0≤i<2k. The number of prefix bits is denoted by n_{P}, the number of suffix bits is denoted by n_{S}. For the Golomb-Rice code, the number of suffix bits is n_{S}=k. When encoding a value v, the number of prefix bits is determined by

$${n}_{P} = 1 + ⌊ \frac{v}{{2}^{k}} ⌋ .$$

The suffix then is the nₛ-bit binary representation of

v_{S}=v−2k(n_{P}−1).

Accordingly, the value v can be reconstructed from the code word c by

v=C_{grk}ⁱ(c)=2^{k}(n_{P}−1)+Σᵢ₌₀^{k-1}xᵢ·2ⁱ.

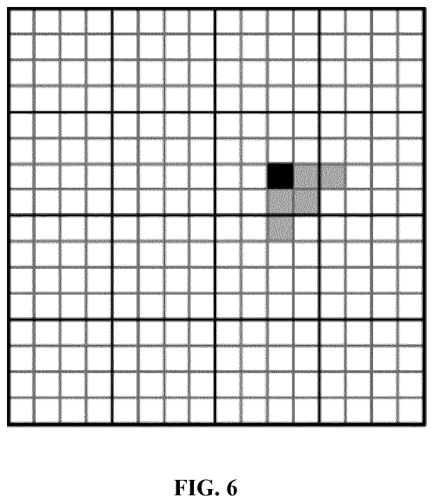

In general, at least one example of an embodiment can involve Rice parameter derivation for transform residual coding. In transform residual coding, for each coefficient, the remaining absolute levels abs_remainder and the intermediate values dec_abs_level are adaptively binarized using the Rice parameters derived depending on the levels of the bottom and right residual coefficient. The unified (same) Rice parameter (RiceParam) derivation is used for Pass 2 and Pass 3 in residual coding for transform coefficients. The only difference is that baseLevel is set to 4 and 0 for Pass 2 and Pass 3, respectively. Rice parameters are determined not only based on a sum of absolute levels (sumAbs) of neighboring five transform coefficients in local neighbor template in FIG. 6, but the corresponding base level is also taken into consideration as follow:

RiceParam=RiceParamTable[max(min(31,sumAbs−5*baseLevel),0)].

In FIG. 6, a local neighbor template used for Rice parameter derivation is illustrated. The black square in FIG. 6 specifies the current scan position and the gray squares represent the local neighborhood used. Given the variable SumAbs, the Rice parameter designated RiceParam is derived as specified in Table 2.

TABLE 2
Specification of RiceParam based on SumAbs

| SumAbs | 0 | 1 | 2 | 3 | 4 | 5 | 6 | 7 | 8 | 9 | 10 | 11 | 12 | 13 | 14 | 15 |
|---|---|---|---|---|---|---|---|---|---|---|---|---|---|---|---|---|
| RiceParam | 0 | 0 | 0 | 0 | 0 | 0 | 0 | 1 | 1 | 1 | 1 | 1 | 1 | 1 | 2 | 2 |
| SumAbs | 16 | 17 | 18 | 19 | 20 | 21 | 22 | 23 | 24 | 25 | 26 | 27 | 28 | 29 | 30 | 31 |
| RiceParam | 2 | 2 | 2 | 2 | 2 | 2 | 2 | 2 | 2 | 2 | 2 | 2 | 3 | 3 | 3 | 3 |

In general, at least one example of an embodiment can involve Rice parameter derivation for transform skip residual coding. In residual coding of a transform skip block, for each sample, the remaining absolute levels are adaptively binarized using the Rice parameters derived depending on the levels of the top and left residual samples. An example of an approach can involve a fixed codeword (RiceParam k=1) being used to replace this per-sample adaptive codeword derivation for transform skip residual coding. As mentioned above, a fixed Rice parameter (RiceParam k=1) is applied for transform skip residual coding, while the Rice parameters derivation still depends on the bottom and right neighbors inside a local neighbor template for the normal transform residual coding. That is, the approach is different between the residual coding for transform blocks and transform skip blocks. At least one example of an embodiment described herein involves some reduced complexity and unified approaches to Rice parameter derivation.

Summarizing the above, in order to code abs_remainder and dec_abs_level, a Golomb-Rice code is applied for binarization of the level value. Therefore, the Rice parameter k of Golomb-Rice code needs to be determined. Moreover, an approach to Transform Skip (TS) residual coding can be significantly different from the transform residual coding process of a transform block. For example, one of these differences between TS residual coding and transform residual coding can involve Rice parameter derivation. In transform residual coding, the Rice parameters derivation can depend on the bottom and right neighbors inside a local neighbor template. For TS residual coding, an approach is for the Rice parameter to be fixed (e.g., RiceParam k=1). In general, at least one example of an embodiment described herein involves unifying the Rice parameter derivation for coefficient level coding.

However, in order to guarantee a sufficiently high throughput, consideration should be given to maximization of bypass-coded bins under the constraint of avoiding excessive loss or reduction of coding efficiency. In addition, there could also be other throughput issues even with bypass coding, e.g., due to determining Rice parameters based on the number of neighbors included or considered in a local neighbor template, e.g., neighboring five transform coefficients in a local neighbor template. That is, the throughput is determined based on the number of binary symbols (bins) that can be processed per second. The throughput bottleneck is primarily due to the bin dependencies. For example, if the rice parameter derivation of a coefficient depends on the value of another coefficient decoded, then speculative computations based on the dependencies and also the memory accesses are required, which increases critical path delay. Therefore, the throughput can be improved by reducing the neighboring dependences.

In general, at least one example of an embodiment described herein can involve reducing these neighboring dependencies to reduce the complexity of the Rice parameter derivation process while also increasing the throughput. That is, in general, at least one example of an embodiment described herein involves reducing the complexity of the Rice parameter derivation for coefficient level coding. Reducing the complexity of the Rice derivation process can involve, for example, reducing the number of neighbors included in a local neighbour template for Rice parameter derivation as mentioned above and/or modifying the calculations involved in Rice parameter derivation to reduce complexity.

In general, at least one example of an embodiment involving unifying and/or reducing complexity of the Rice parameter derivation for the transform residual coding process and TS residual coding process can involve one or more of the following.
1. In transform residual coding, a reduced local neighboring template (e.g., a local neighbor template including a number of neighbors less than a value such as five, i.e., the template includes less than five neighbors) is used in Rice parameter derivation, thereby reducing the complexity of the Rice parameter derivation process;
2. In transform residual coding, a fixed Rice parameter (RiceParam k=1) is used rather than per-sample adaptive codeword derivation, thereby unifying and/or reducing the complexity of the Rice parameter derivation process;
3. In transform residual coding, Rice parameter derivation is based on the pre-defined frequency region or the scanning position of the coefficient, thereby reducing the complexity of the Rice parameter derivation process.

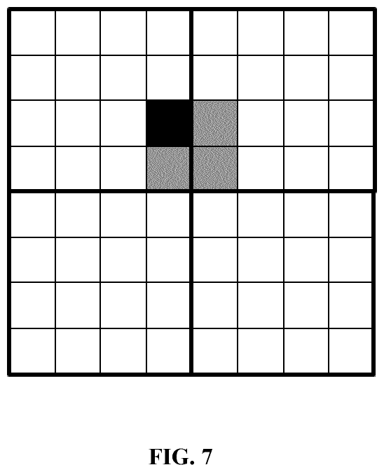

As discussed above, Rice parameter for transform residual coding can be determined based on sum of absolute levels (sumAbs) of a relatively large number of neighboring transform coefficients, e.g., five, in a local neighbor template such as the example shown in FIG. 6. In order to reduce the neighboring dependencies for high throughput, in general at least one example of an embodiment involves reducing the local neighboring template or obtaining Rice parameter information based on using a reduced number of neighbors, e.g., fewer than five such as three, for Rice parameter derivation for transform residual coding. For example, FIG. 7 shows an example of a neighbor template that, rather than using a relatively high number of neighbors such as five, uses a local neighboring template with only three neighbors (bottom, right, right-bottom) for determining the Rice parameters. In FIG. 1, the black square designates the current scan position and the gray squares represent the local neighborhood used.

An example of an embodiment of a Rice parameter derivation including one or more of the features described herein for abs_remainder and dec_abs_level derivation is illustrated in the Following Example 1.

### Example 1: Rice Parameter Derivation Process for abs_remainder[ ] and dec_abs_level[ ]

Inputs to this process are the base level baseLevel, the colour component index cldx, the luma location (x0, y0) specifying the top-left sample of the current transform block relative to the top-left sample of the current picture, the current coefficient scan location (xC, yC), the binary logarithm of the transform block width log 2TbWidth, and the binary logarithm of the transform block height log 2TbHeight.
Output of this process is the Rice parameter cRiceParam.
Given the array AbsLevel[x][y] for the transform block with component index cldx and the top-left luma location (x0, y0), the variable locSumAbs is derived as specified by the following pseudo code:

```
locSumAbs = 0
if(xC < (1 << log2TbWidth) − 1)
  locSumAbs += AbsLevel[ xC + 1 ][ yC ]
if(yC < (1 << log2TbHeight) − 1)
  locSumAbs += AbsLevel[ xC ][ yC + 1 ]
locSumAbs = Clip3( 0, 31, locSumAbs − baseLevel * 5 )
```

Given the variable locSumAbs, the Rice parameter cRiceParam is derived as specified in Table 3 below.
When baseLevel is equal to 0, the variable ZeroPos[n] is derived as follows:

ZeroPos[n]=(QState<2?1:2)<<cRiceParam

TABLE 3
Specification of cRiceParam based on locSumAbs

| locSumAbs | 0 | 1 | 2 | 3 | 4 | 5 | 6 | 7 | 8 | 9 | 10 | 11 | 12 | 13 | 14 | 15 |
|---|---|---|---|---|---|---|---|---|---|---|---|---|---|---|---|---|
| cRiceParam | 0 | 0 | 0 | 0 | 0 | 0 | 0 | 1 | 1 | 1 | 1 | 1 | 1 | 1 | 2 | 2 |
| locSumAbs | 16 | 17 | 18 | 19 | 20 | 21 | 22 | 23 | 24 | 25 | 26 | 27 | 28 | 29 | 30 | 31 |
| cRiceParam | 2 | 2 | 2 | 2 | 2 | 2 | 2 | 2 | 2 | 2 | 2 | 2 | 3 | 3 | 3 | 3 |

In general, an example of at least one variant of the example embodiment illustrated above in Example 1 can involve the number of neighbors used in the local neighboring template being any value less than five.
In general, an example of at least one variant of the example embodiment illustrated above in Example 1 can involve different number of neighbors used in the local neighboring template for abs_remainder and dec_abs_level in transform residual coding.

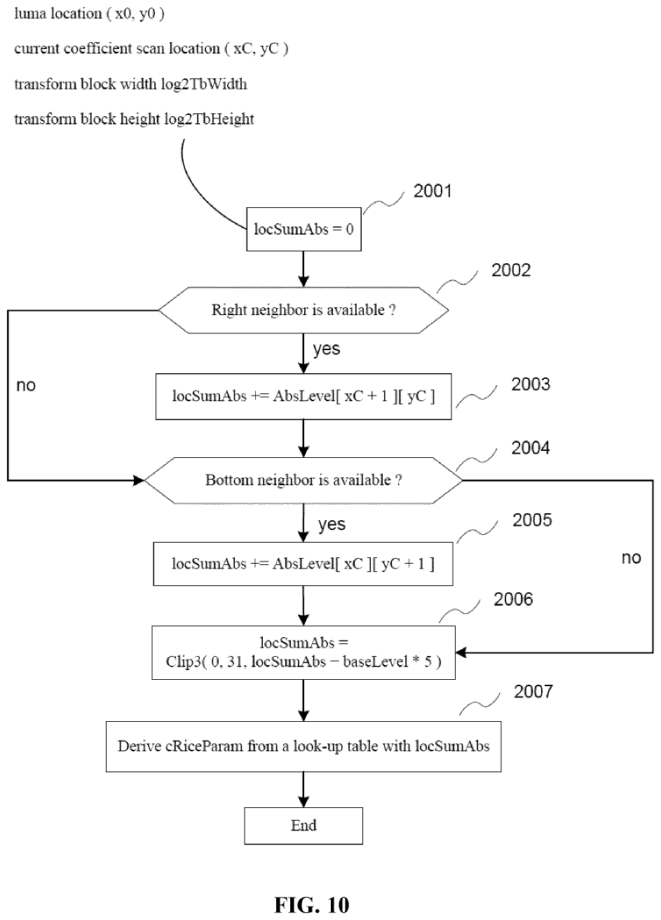

FIG. 10 shows a flow chart illustrating an example of an embodiment corresponding to Example 1 described above. In FIG. 10, a variable locSumAbs is initialized to zero at 2001. Following the initialization, a determination is made at 2002 as to whether the Right neighbor in the local neighbor template is available (e.g., gray square to the right of the black square as illustrated in FIG. 7). If so, the variable locSumAbs is defined as shown at 2003 followed by a check of the availability of the bottom neighbor at 2004 (e.g., gray square below the black square in FIG. 7). If the check at 2002 is false (“no”) then 2003 is skipped and operation continues at 2004 as described. If the check at 2004 is true (“yes”) then variable locSumAbs is defined as shown at 2005 followed by the modification of the value of locSumAbs shown at 2006. If the check at 2004 is false (“no”) then 2005 is skipped and 2004 is followed by 2006 as described. After 2006, the value of cRiceParam is determined at 2007 based on locSumAbs, e.g., from a lookup table such as that shown above in Table 3.

In general, at least one other example of an embodiment can involve a fixed Rice parameter for transform residual coding. That is, the present example involves using a fixed binary codeword (e.g., cRiceParam equal to k) for the abs_remainder and dec_abs_level in transform residual coding to further remove the neighboring dependencies and also unify the design. An example of an embodiment of the described codeword binarization process is illustrated in the below in Example 2 wherein, in accordance with the present example, the per-sample codeword determination can be removed, thereby increasing the throughput.

### Example 2: Rice Parameter Derivation Process for abs_remainder[ ] and dec_abs_level[ ]

The Rice parameter cRiceParam is set to K.
When baseLevel is equal to 0, the variable ZeroPos[n] is derived as follows:

ZeroPos[n]=(QState<2 ?1:2)<<cRiceParam

Binarization Process for abs_remainder[ ]
Input to this process is a request for a binarization for the syntax element abs_remainder[n].
Output of this process is the binarization of the syntax element.
The variables lastAbsRemainder and lastRiceParam are derived as follows:
If this process is invoked for the first time for the current sub-block index i, lastAbsRemainder and lastRiceParam are both set equal to 0.
Otherwise (this process is not invoked for the first time for the current sub-block index i), lastAbsRemainder and lastRiceParam are set equal to the values of abs_remainder[n] and cRiceParam, respectively, that have been derived during the last invocation of the binarization process for the syntax element abs_remainder[n] as specified in this clause.
   The Rice parameter cRiceParam is set to K.
   The variable cMax is derived from cRiceParam as:

cMax=6<<cRiceParam

The binarization of the syntax element abs_remainder[n] is a concatenation of a prefix bin string and (when present) a suffix bin string.

For the derivation of the prefix bin string, the following applies:—
The prefix value of abs_remainder[n], prefixVal, is derived as follows:

prefixVal=Min(cMax,abs_remainder[n])
The prefix bin string is specified by invoking the TR binarization process for prefixVal with the variables cMax and cRiceParam as inputs.
   When the prefix bin string is equal to the bit string of length 6 with all bits equal to 1, the suffix bin string is present and it is derived as follows:
The suffix value of abs_remainder[n], suffixVal, is derived as follows:

suffixVal=abs_remainder[n]−cMax
The suffix bin string is specified by invoking the limited k-th order EGk binarization process for the binarization of suffixVal with the Exp-Golomb order k set equal to cRiceParam+1, variable cRiceParam, variable log 2TransformRange set equal to 15 and variable maxPreExtLen set equal to 11 as input.
   Binarization process for dec_abs_level[ ]
   Input to this process is a request for a binarization of the syntax element dec_abs_level[n]. Output of this process is the binarization of the syntax element.
   The Rice parameter cRiceParam is set to K.
   The variable cMax is derived from cRiceParam as:

cMax=6<<cRiceParam

The binarization of dec_abs_level[n] is a concatenation of a prefix bin string and (when present) a suffix bin string.
For the derivation of the prefix bin string, the following applies:—
The prefix value of dec_abs_level[n], prefixVal, is derived as follows:

prefixVal=Min(cMax,dec_abs_level[n])
The prefix bin string is specified by invoking the TR binarization process for prefixVal with the variables cMax and cRiceParam as inputs.
   When the prefix bin string is equal to the bit string of length 6 with all bits equal to 1, the suffix bin string is present and it is derived as follows:
The suffix value of dec_abs_level[n], suffixVal, is derived as follows:

suffixVal=dec_abs_level[n]−cMax
The suffix bin string is specified by invoking the limited k-th order EGk binarization process for the binarization of suffixVal with the Exp-Golomb order k set equal to cRiceParam+1, variable cRiceParam, variable log 2TransformRange set equal to 15 and variable maxPreExtLen set equal to 11 as input.

In general, an example of at least one variant of the example embodiment illustrated above in Example 2 can involve the fixed Rice parameter k could be set as different values for abs_remainder and dec_abs_level in transform residual coding.

In general, an example of at least one variant of the example embodiment illustrated above in Example 2 can involve the fixed Rice parameter k could be set as different values in transform residual coding and TS residual coding.

In general, at least one other example of an embodiment can involve deriving the Rice parameter based on the frequency region or the coefficient scanning position for transform residual coding. As described above and illustrated in Example 2, an example of an embodiment can involve a fixed Rice parameter used for the abs_remainder and dec_abs_level of the coefficients at all the scanning positions. Doing so will remove the neighboring dependencies, thereby reducing the amount of speculative calculation related with neighbors and increasing the throughput. In the embodiment of Example 2, the codeword binarization might not be adapted to each sample optimally, since only one single Rice parameter could be chosen.

In general, at least one example of an embodiment provides for alternative trade-offs between removing the neighboring dependencies and keeping the per-sample codeword adaptively binarized by providing for deriving the Rice parameter based on the frequency region or the coefficient scanning position for transform residual coding. As an example, adaptive binary codewords can be used for the abs_remainder and dec_abs_level according to the frequency region instead of the neighboring level information.

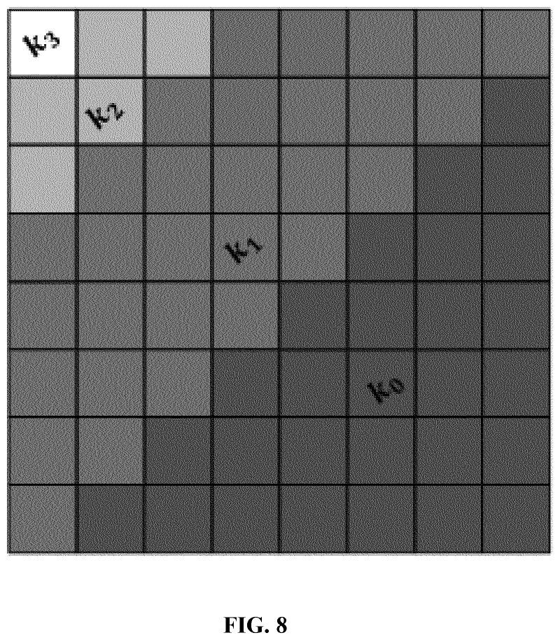

In general, at least one example of an embodiment can involve one TB being split into a plurality of frequency regions, e.g., up to four frequency regions, to capture the characteristics of transform coefficients at different frequencies. The splitting method can be fixed regardless of the TB size, as illustrated on FIG. 8. For the example in FIG. 8 involving four regions, each TB is split into four regions marked with different greyscales, and the Rice parameters assigned to each region are shown, where k₀ to k₃ are predefined Rice parameters.

The Rice parameter RiceParam k which is used for codeword binarization of the coefficient is decided by comparing diagonal position d of the coefficient with predefined thresholds TH₁ to TH₃ satisfying (TH₁<TH₂<TH₃):

k=d<TH₁?k₃:(d<TH₂?k₂:(d<TH₃?k₁:k₀))

where diagonal position d is the sum of the horizontal and vertical coordinates of a current scan position inside the TB:

d=posX+posY

An example of an embodiment of a Rice parameter derivation including one or more of the features described herein is illustrated below in Example 3.

### Example 3: Rice Parameter Derivation Process for abs_remainder[ ] and dec_abs_level[ ]

Inputs to this process is the current coefficient scan location (xC, yC).
Output of this process is the Rice parameter cRiceParam.
Given the current coefficient scan location (xC, yC), the variable cRiceParam is derived as specified by the following pseudo code:

```
diag = xC+ yC
if(diag < TH₁)
{
  cRiceParam = k₃
}
else if(diag < TH₂)
{
  cRiceParam = k₂
}
else if(diag < TH₃)
{
  cRiceParam = k₁
}
else
{
  cRiceParam = k₀
}
```

When baseLevel is equal to 0, the variable ZeroPos[n] is derived as follows:

ZeroPos[n]=(QState<2?1:2)<<cRiceParam

Binarization Process for abs_remainder[ ]
Input to this process is a request for a binarization for the syntax element abs_remainder[n], the current coefficient scan location (xC, yC).
Output of this process is the binarization of the syntax element.
The variables lastAbsRemainder and lastRiceParam are derived as follows:
If this process is invoked for the first time for the current sub-block index i, lastAbsRemainder and lastRiceParam are both set equal to 0.
Otherwise (this process is not invoked for the first time for the current sub-block index i), lastAbsRemainder and lastRiceParam are set equal to the values of abs_remainder[n] and cRiceParam, respectively, that have been derived during the last invocation of the binarization process for the syntax element abs_remainder[n] as specified in this example.
   The Rice parameter cRiceParam is derived as follows:
If transform skip flag[x0][y0][cldx] is equal to 1, the Rice parameter cRiceParam is set equal to 1.
Otherwise, the Rice parameter cRiceParam is derived by invoking the Rice parameter derivation process for abs_remainder[ ] as specified above in this Example 3 with the current coefficient scan location (xC, yC) as inputs.
   The variable cMax is derived from cRiceParam as:

cMax=6<<cRiceParam

The binarization of the syntax element abs_remainder[n] is a concatenation of a prefix bin string and (when present) a suffix bin string.
For the derivation of the prefix bin string, the following applies:—
The prefix value of abs_remainder[n], prefixVal, is derived as follows:

prefixVal=Min(cMax,abs_remainder[n])
The prefix bin string is specified by invoking the TR binarization process for prefixVal with the variables cMax and cRiceParam as inputs.
   When the prefix bin string is equal to the bit string of length 6 with all bits equal to 1, the suffix bin string is present and it is derived as follows:
The suffix value of abs_remainder[n], suffixVal, is derived as follows:

suffixVal=abs_remainder[n]−cMax
The suffix bin string is specified by invoking the limited k-th order EGk binarization process for the binarization of suffixVal with the Exp-Golomb order k set equal to cRiceParam+1, variable cRiceParam, variable log 2TransformRange set equal to 15 and variable maxPreExtLen set equal to 11 as input.
   Binarization Process for dec_abs_level[ ]
   Input to this process is a request for a binarization of the syntax element dec_abs_level[n], the current coefficient scan location (xC, yC).
   Output of this process is the binarization of the syntax element.
   The Rice parameter cRiceParam is derived by invoking the Rice parameter derivation process for abs_remainder[ ] as specified above with the current coefficient scan location (xC, yC) as inputs.
   The variable cMax is derived from cRiceParam as:

cMax=6<<cRiceParam

The binarization of dec_abs_level[n] is a concatenation of a prefix bin string and (when present) a suffix bin string.
For the derivation of the prefix bin string, the following applies:
The prefix value of dec_abs_level[n], prefixVal, is derived as follows:

prefixVal=Min(cMax,dec_abs_level[n])
The prefix bin string is specified by invoking the TR binarization process for prefixVal with the variables cMax and cRiceParam as inputs.
   When the prefix bin string is equal to the bit string of length 6 with all bits equal to 1, the suffix bin string is present and it is derived as follows:
The suffix value of dec_abs_level[n], suffixVal, is derived as follows:

suffixVal=dec_abs_level[n]−cMax
The suffix bin string is specified by invoking the limited k-th order EGk binarization process for the binarization of suffixVal with the Exp-Golomb order k set equal to cRiceParam+1, variable cRiceParam, variable log 2TransformRange set equal to 15 and variable maxPreExtLen set equal to 11 as input.

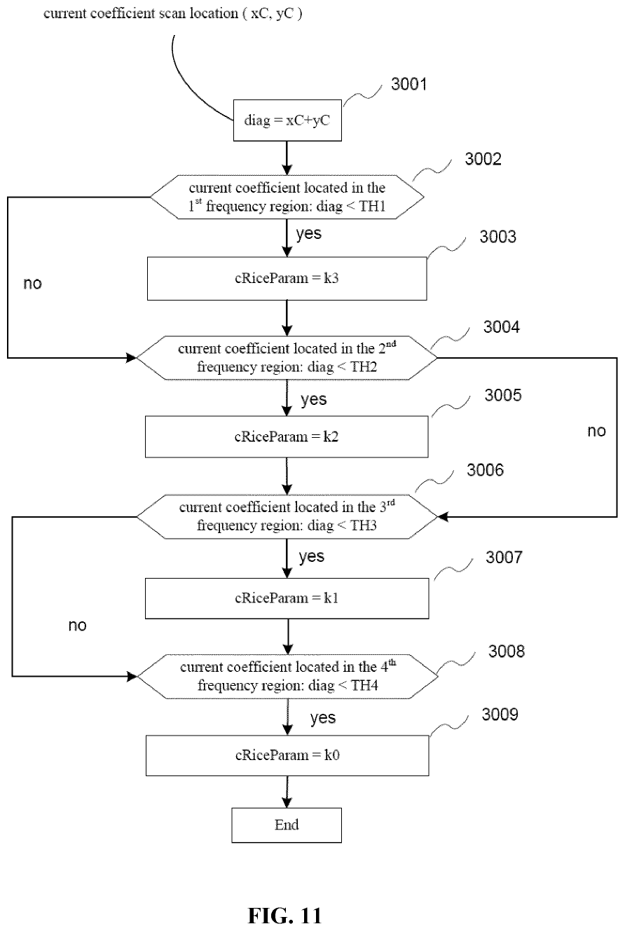

FIG. 11 shows a flow chart illustrating an example of an embodiment corresponding to Example 3 described above. As explained above, Example 3 involves the Rice parameter which is used for codeword binarization of a coefficient being decided by comparing diagonal position of the coefficient with predefined thresholds defining different frequency regions in a transform block (TB) as illustrated in FIG. 8. In FIG. 11, a diagonal position designated variable “diag” is initialized at 3001 to the sum of the x and y coordinates of the current coefficient scan location. Then, at 3002, the value of diag is compared to a first value or threshold TH1 to determine if the current coefficient location is in a first frequency region having a boundary defined by TH1. If so (“yes” at 3002) then cRiceParam is set equal to k3 at 3003. If the check at 3002 is false (“no”) then 3003 is skipped and operation continues at 3004 where variable diag is compared to a second value or threshold TH2 to determine if the location is in a second region. If so (“yes” at 3004) then cRiceParam is set equal to k2 at 3005. Similar checks occur at 3006 and 3008 vs. respective values or thresholds TH3 and TH4 to determine whether the location of the current coefficient is in the third or fourth regions and, if so, then cRiceParam is set equal to k1 or k0, respectively, at 3007 or 3009.

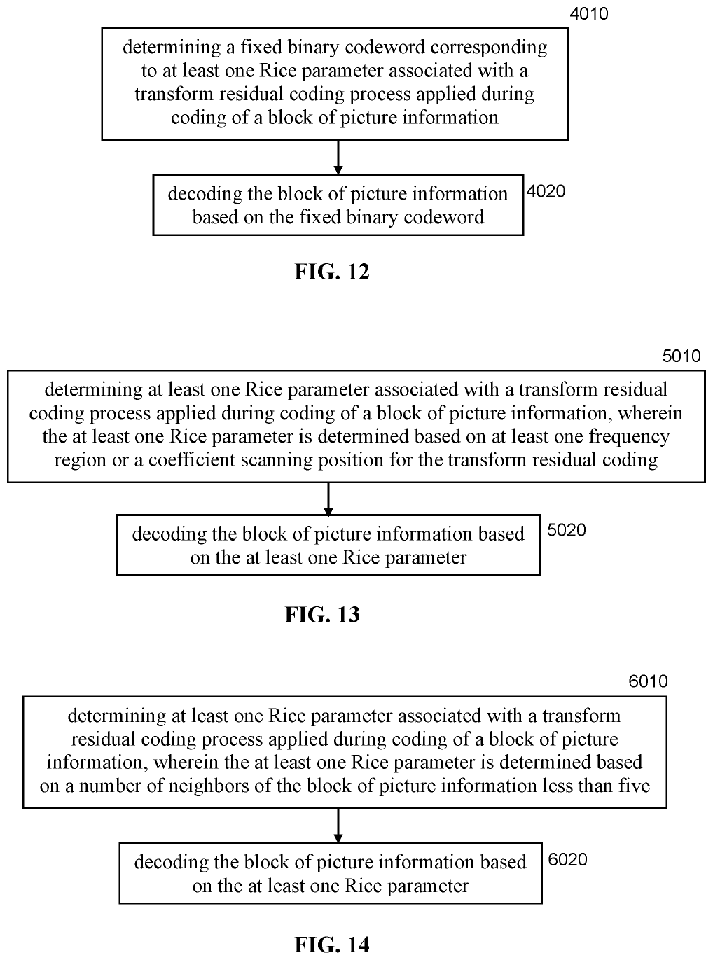

FIGS. 12 to 14 illustrate other examples of embodiments in accordance with one or more aspects or features of Examples 1 to 3 described above. In the example of an embodiment illustrated in FIG. 12, operation at 4010 provides for determining a fixed binary codeword, e.g., as in Example 2 described above, where the fixed binary codeword corresponds to at least one Rice parameter associated with a transform residual coding process applied during coding of a block of picture information. Then, at 4020, decoding of the block of picture information occurs based on the fixed binary codeword. In an example of an embodiment illustrated in FIG. 13, operation at 5010 provides for determining at least one Rice parameter associated with a transform residual coding process applied during coding of a block of picture information, wherein the at least one Rice parameter is determined based on at least one frequency region or a coefficient scanning position for the transform residual coding, e.g., as in Example 3 described above. Then, at 5020 decoding the block of picture information based on the at least one Rice parameter occurs. In the example of FIG. 14, operation at 6010 provides for determining at least one Rice parameter associated with a transform residual coding process applied during coding of a block of picture information, wherein the at least one Rice parameter is determined based on a number of neighbors of the block of picture information less than five, e.g., as in Example 1 described above. Then, at 6020 decoding the block of picture information based on the at least one Rice parameter occurs.

In general, various modifications of the examples of embodiments described herein are envisioned. For example, a variant of at least one of the example embodiments described herein, e.g., the example described above with regard to Example 3, can involve the number of frequency regions being set at values other than four. The number of Rice parameter could also be set at values other than four. Another example of a variant of at least one of the example embodiments described herein, e.g., the example described above with regard to Example 3, can involve one or more frequency regions sharing the same Rice parameter. Another example of a variant of at least one of the example embodiments described herein, e.g., the example described above with regard to Example 3, can involve the frequency region splitting logic being different for abs_remainder and dec_abs_level. Another example of a variant of at least one of the example embodiments described herein, e.g., the example described above with regard to Example 3, can involve the set of Rice parameter values being different for luma and chroma components. Another example of a variant of at least one of the example embodiments described herein, e.g., the example described above with regard to Example 3, can involve the frequency region splitting logic being different for luma and chroma components. Another example of a variant of at least one of the example embodiments described herein, e.g., the example described above with regard to Example 3, can involve the Rice parameter k being decided by comparing the scanning position of the coefficient with other logics. As will be apparent to one skilled in the art, the syntax, logic, etc., illustrated in the examples of embodiments described herein, e.g., Examples 1 through 3 above, can be implemented in various ways, i.e., with different syntax, logic, etc. The examples provided herein are intended only as non-limiting illustrations of one approach. Various other approaches such as the variants described herein are envisioned and are within the scope of the present disclosure.

A variety of examples of embodiments, including tools, features, models, approaches, etc., are described herein and include, but are not limited to:
in general, reducing the neighboring dependencies in transform residual coding;
in general, reducing the neighboring dependencies in Rice parameter derivation in transform residual coding;
reducing the neighboring dependencies in transform residual coding, thereby providing for increased throughput;
reducing the neighboring dependencies in Rice parameter derivation in transform residual coding, thereby providing for an increase in a processing throughput, wherein the increase in the processing throughput is determined based on a number of binary symbols (bins) processed per second;
in transform residual coding, selecting a local neighboring template to be used for Rice parameter derivation process for the abs_remainder and dec_abs_level, wherein the local neighboring template is based on a number of neighbors less than a value;
in transform residual coding, selecting a local neighboring template to be used for Rice parameter derivation process for the abs_remainder and dec_abs_level, wherein the local neighboring template is based on a number of neighbors less than a value and wherein the value is five;
in transform residual coding, reducing the number of neighbors in a local neighboring template used in Rice parameter derivation;
in transform residual coding, the number of neighbors used in the local neighboring template could be any value less than a particular value, e.g., five;
in transform residual coding, the number of neighbors used in the local neighboring template in Rice parameter derivation could be any value less than a particular value, e.g., five;
in transform residual coding, remove the neighboring dependencies, wherein doing so can provide increased throughput;
in transform residual coding, remove the neighboring dependencies in Rice parameter derivation, wherein doing so can provide an increase in a processing throughput and wherein the increase in the processing throughput is determined based on a number of binary symbols (bins) processed per second;
in transform residual coding, use a fixed Rice parameter (e.g. cRiceParam equal to k) for at least first and second parameters, e.g., a parameter for syntax abs_remainder and a parameter for syntax dec_abs_level;
in transform residual coding, the Rice parameter k can be unified with that for transform skip (TS) residual coding;
in transform residual coding, the Rice parameter k can be set as 1 and unified with the TS residual coding;
in transform residual coding and TS residual coding, the Rice parameter k could be fixed and set at any same value, thereby providing for unification of the transform residual coding and the TS residual coding;
removing the neighboring dependencies for high throughput while keeping the per-sample codeword adaptively binarized for better coding efficiency;
in transform residual coding, deriving the Rice parameter for at least one parameter=, e.g., one or more of a parameter for syntax abs_remainder and a parameter for syntax dec_abs_level based on the frequency region or the coefficient scanning position;
deciding the Rice parameter k by comparing diagonal position of the coefficient with a particular value or values, e.g., predefined values or thresholds;
setting the number of frequency regions and/or the number of Rice parameters to any value;
the Rice parameter k could be assigned with one frequency region;
sharing the same Rice parameter k among one or more frequency regions;
the set of Rice parameter values could be different for luma and chroma components;
the frequency regions splitting implementation, e.g., logic, could be different for luma and chroma components;
deciding the Rice parameter k based on comparing the scanning position of the coefficient with other logics.

Many of these examples are described with specificity and, at least to show the individual characteristics, are often described in a manner that may sound limiting. However, this is for purposes of clarity in description, and does not limit the application or scope of those aspects. Indeed, all of the different aspects can be combined and interchanged to provide further aspects. Moreover, the embodiments, features, etc. can be combined and interchanged with others described in earlier filings as well.

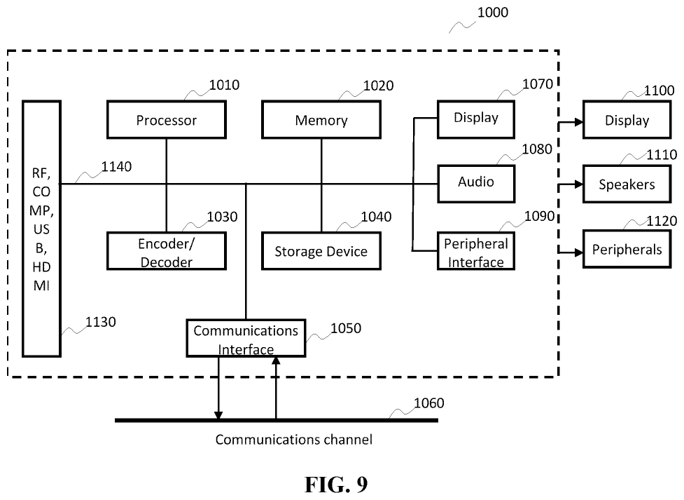

In general, the examples of embodiments described and contemplated herein can be implemented in many different forms. FIGS. 1 and 2 described above and FIG. 9 described below provide some examples of embodiments, but other embodiments are contemplated and the discussion of FIGS. 1, 2 and 9 does not limit the breadth of the implementations.

At least one aspect of one or more examples of embodiments described herein generally relates to video encoding and decoding, and at least one other aspect generally relates to transmitting a bitstream generated or encoded. These and other aspects can be implemented in various embodiments such as a method, an apparatus, a computer readable storage medium having stored thereon instructions for encoding or decoding video data according to any of the methods described, and/or a computer readable storage medium having stored thereon a bitstream generated according to any of the methods described.

It should be understood that the drawings provided herein, and sections of text or syntax provided herein that may relate to industry standards or standards-related documents are for purposes of illustrating examples of various aspects and embodiments and are not necessarily the only possible configurations. Throughout the various figures, like reference designators refer to the same or similar features.

In the present application, the terms “reconstructed” and “decoded” may be used interchangeably, the terms “pixel” and “sample” may be used interchangeably, the terms “image,” “picture” and “frame” may be used interchangeably.

Various methods are described herein, and each of the methods comprises one or more steps or actions for achieving the described method. Unless a specific order of steps or actions is required for proper operation of the method, the order and/or use of specific steps and/or actions may be modified or combined.

Various methods and other aspects described in this application can be used to modify modules, e.g., module 145 included in the example of a video encoder embodiment 100 illustrated in FIG. 1 and module 230 included in the example of a video decoder embodiment 200 illustrated in FIG. 2. Moreover, the various embodiments, features, etc. described herein are not limited to VVC or HEVC, and can be applied, for example, to other standards and recommendations, whether pre-existing or future-developed, and extensions of any such standards and recommendations (including VVC and HEVC). Unless indicated otherwise, or technically precluded, the aspects described in this application can be used individually or in combination.

Various numeric values are used in the present application, for example, the size of maximum quantization matrix, the number of block sizes considered, etc. The specific values are for example purposes and the aspects described are not limited to these specific values.

FIG. 9 illustrates a block diagram of an example of a system in which various features and embodiments are implemented. System 1000 in FIG. 9 can be embodied as a device including the various components described below and is configured to perform or implement one or more of the examples of embodiments, features, etc. described in this document. Examples of such devices include, but are not limited to, various electronic devices such as personal computers, laptop computers, smartphones, tablet computers, digital multimedia set top boxes, digital television receivers, personal video recording systems, connected home appliances, and servers. Elements of system 1000, singly or in combination, can be embodied in a single integrated circuit (IC), multiple ICs, and/or discrete components. For example, in at least one embodiment, the processing and encoder/decoder elements of system 1000 are distributed across multiple ICs and/or discrete components. In various embodiments, the system 1000 is communicatively coupled to one or more other systems, or other electronic devices, via, for example, a communications bus or through dedicated input and/or output ports. In general, the system 1000 is configured to implement one or more of the examples of embodiments, features, etc. described in this document.

The system 1000 includes at least one processor 1010 configured to execute instructions loaded therein for implementing, for example, the various aspects described in this document. Processor 1010 can include embedded memory, input output interface, and various other circuitries as known in the art. The system 1000 includes at least one memory 1020 (e.g., a volatile memory device, and/or a non-volatile memory device). System 1000 includes a storage device 1040, which can include non-volatile memory and/or volatile memory, including, but not limited to, Electrically Erasable Programmable Read-Only Memory (EEPROM), Read-Only Memory (ROM), Programmable Read-Only Memory (PROM), Random Access Memory (RAM), Dynamic Random Access Memory (DRAM), Static Random Access Memory (SRAM), flash, magnetic disk drive, and/or optical disk drive. The storage device 1040 can include an internal storage device, an attached storage device (including detachable and non-detachable storage devices), and/or a network accessible storage device, as non-limiting examples.

System 1000 includes an encoder/decoder module 1030 configured, for example, to process data to provide an encoded video or decoded video, and the encoder/decoder module 1030 can include its own processor and memory. The encoder/decoder module 1030 represents module(s) that can be included in a device to perform the encoding and/or decoding functions. As is known, a device can include one or both of the encoding and decoding modules. Additionally, encoder/decoder module 1030 can be implemented as a separate element of system 1000 or can be incorporated within processor 1010 as a combination of hardware and software as known to those skilled in the art.

Program code to be loaded onto processor 1010 or encoder/decoder 1030, e.g., to perform or implement one or more examples of embodiments, features, etc., described in this document, can be stored in storage device 1040 and subsequently loaded onto memory 1020 for execution by processor 1010. In accordance with various embodiments, one or more of processor 1010, memory 1020, storage device 1040, and encoder/decoder module 1030 can store one or more of various items during the performance of the processes described in this document. Such stored items can include, but are not limited to, the input video, the decoded video or portions of the decoded video, the bitstream, matrices, variables, and intermediate or final results from the processing of equations, formulas, operations, and operational logic.

In some embodiments, memory inside of the processor 1010 and/or the encoder/decoder module 1030 is used to store instructions and to provide working memory for processing that is needed during encoding or decoding. In other embodiments, however, a memory external to the processing device (for example, the processing device can be either the processor 1010 or the encoder/decoder module 1030) is used for one or more of these functions. The external memory can be the memory 1020 and/or the storage device 1040, for example, a dynamic volatile memory and/or a non-volatile flash memory. In several embodiments, an external non-volatile flash memory is used to store the operating system of, for example, a television. In at least one embodiment, a fast external dynamic volatile memory such as a RAM is used as working memory for video coding and decoding operations, such as for MPEG-2 (MPEG refers to the Moving Picture Experts Group, MPEG-2 is also referred to as ISO/IEC 13818, and 13818-1 is also known as H.222, and 13818-2 is also known as H.262), HEVC (HEVC refers to High Efficiency Video Coding, also known as H.265 and MPEG-H Part 2), or VVC (Versatile Video Coding, a new standard being developed by JVET, the Joint Video Experts Team).

The input to the elements of system 1000 can be provided through various input devices as indicated in block 1130. Such input devices include, but are not limited to, (i) a radio frequency (RF) portion that receives an RF signal transmitted, for example, over the air by a broadcaster, (ii) a Component (COMP) input terminal (or a set of COMP input terminals), (iii) a Universal Serial Bus (USB) input terminal, and/or (iv) a High Definition Multimedia Interface (HDMI) input terminal. Other examples, not shown in FIG. 3, include composite video.

In various embodiments, the input devices of block 1130 have associated respective input processing elements as known in the art. For example, the RF portion can be associated with elements suitable for (i) selecting a desired frequency (also referred to as selecting a signal, or band-limiting a signal to a band of frequencies), (ii) downconverting the selected signal, (iii) band-limiting again to a narrower band of frequencies to select (for example) a signal frequency band which can be referred to as a channel in certain embodiments, (iv) demodulating the downconverted and band-limited signal, (v) performing error correction, and (vi) demultiplexing to select the desired stream of data packets. The RF portion of various embodiments includes one or more elements to perform these functions, for example, frequency selectors, signal selectors, band-limiters, channel selectors, filters, downconverters, demodulators, error correctors, and demultiplexers. The RF portion can include a tuner that performs various of these functions, including, for example, downconverting the received signal to a lower frequency (for example, an intermediate frequency or a near-baseband frequency) or to baseband. In one set-top box embodiment, the RF portion and its associated input processing element receives an RF signal transmitted over a wired (for example, cable) medium, and performs frequency selection by filtering, downconverting, and filtering again to a desired frequency band. Various embodiments rearrange the order of the above-described (and other) elements, remove some of these elements, and/or add other elements performing similar or different functions. Adding elements can include inserting elements in between existing elements, such as, for example, inserting amplifiers and an analog-to-digital converter. In various embodiments, the RF portion includes an antenna.

Additionally, the USB and/or HDMI terminals can include respective interface processors for connecting system 1000 to other electronic devices across USB and/or HDMI connections. It is to be understood that various aspects of input processing, for example, Reed-Solomon error correction, can be implemented, for example, within a separate input processing IC or within processor 1010 as necessary. Similarly, aspects of USB or HDMI interface processing can be implemented within separate interface ICs or within processor 1010 as necessary. The demodulated, error corrected, and demultiplexed stream is provided to various processing elements, including, for example, processor 1010, and encoder/decoder 1030 operating in combination with the memory and storage elements to process the datastream as necessary for presentation on an output device.

Various elements of system 1000 can be provided within an integrated housing, Within the integrated housing, the various elements can be interconnected and transmit data therebetween using suitable connection arrangement 1140, for example, an internal bus as known in the art, including the Inter-IC (I2C) bus, wiring, and printed circuit boards.

The system 1000 includes communication interface 1050 that enables communication with other devices via communication channel 1060. The communication interface 1050 can include, but is not limited to, a transceiver configured to transmit and to receive data over communication channel 1060. The communication interface 1050 can include, but is not limited to, a modem or network card and the communication channel 1060 can be implemented, for example, within a wired and/or a wireless medium.

Data is streamed, or otherwise provided, to the system 1000, in various embodiments, using a wireless network such as a Wi-Fi network, for example IEEE 802.11 (IEEE refers to the Institute of Electrical and Electronics Engineers). The Wi-Fi signal of these embodiments is received over the communications channel 1060 and the communications interface 1050 which are adapted for Wi-Fi communications. The communications channel 1060 of these embodiments is typically connected to an access point or router that provides access to external networks including the Internet for allowing streaming applications and other over-the-top communications. Other embodiments provide streamed data to the system 1000 using a set-top box that delivers the data over the HDMI connection of the input block 1130. Still other embodiments provide streamed data to the system 1000 using the RF connection of the input block 1130. As indicated above, various embodiments provide data in a non-streaming manner. Additionally, various embodiments use wireless networks other than Wi-Fi, for example a cellular network or a Bluetooth network.

The system 1000 can provide an output signal to various output devices, including a display 1100, speakers 1110, and other peripheral devices 1120. The display 1100 of various embodiments includes one or more of, for example, a touchscreen display, an organic light-emitting diode (OLED) display, a curved display, and/or a foldable display. The display 1100 can be for a television, a tablet, a laptop, a cell phone (mobile phone), or other device. The display 1100 can also be integrated with other components (for example, as in a smart phone), or separate (for example, an external monitor for a laptop). The other peripheral devices 1120 include, in various examples of embodiments, one or more of a stand-alone digital video disc (or digital versatile disc) (DVR, for both terms), a disk player, a stereo system, and/or a lighting system. Various embodiments use one or more peripheral devices 1120 that provide a function based on the output of the system 1000. For example, a disk player performs the function of playing the output of the system 1000.

In various embodiments, control signals are communicated between the system 1000 and the display 1100, speakers 1110, or other peripheral devices 1120 using signaling such as AV.Link, Consumer Electronics Control (CEC), or other communications protocols that enable device-to-device control with or without user intervention. The output devices can be communicatively coupled to system 1000 via dedicated connections through respective interfaces 1070, 1080, and 1090. Alternatively, the output devices can be connected to system 1000 using the communications channel 1060 via the communications interface 1050. The display 1100 and speakers 1110 can be integrated in a single unit with the other components of system 1000 in an electronic device such as, for example, a television. In various embodiments, the display interface 1070 includes a display driver, such as, for example, a timing controller (T Con) chip.

The display 1100 and speaker 1110 can alternatively be separate from one or more of the other components, for example, if the RF portion of input 1130 is part of a separate set-top box. In various embodiments in which the display 1100 and speakers 1110 are external components, the output signal can be provided via dedicated output connections, including, for example, HDMI ports, USB ports, or COMP outputs.

The embodiments can be carried out by computer software implemented by the processor 1010 or by hardware, or by a combination of hardware and software. As a non-limiting example, the embodiments can be implemented by one or more integrated circuits. The memory 1020 can be of any type appropriate to the technical environment and can be implemented using any appropriate data storage technology, such as optical memory devices, magnetic memory devices, semiconductor-based memory devices, fixed memory, and removable memory, as non-limiting examples. The processor 1010 can be of any type appropriate to the technical environment, and can encompass one or more of microprocessors, general purpose computers, special purpose computers, and processors based on a multi-core architecture, as non-limiting examples.

Various generalized as well as particularized embodiments are also supported and contemplated throughout this disclosure. Examples of embodiments in accordance with the present disclosure include but are not limited to the following.

In general, at least one example of an embodiment can involve a method comprising: determining a fixed binary codeword corresponding to at least one Rice parameter associated with a transform residual coding process applied during coding of a block of picture information; and decoding the block of picture information based on the fixed binary codeword.

In general, at least one example of an embodiment can involve apparatus comprising: one or more processors configured to determine a fixed binary codeword corresponding to at least one Rice parameter associated with a transform residual coding process applied during coding of a block of picture information; and decode the block of picture information based on the fixed binary codeword.

In general, at least one example of an embodiment can involve a method comprising: determining a fixed binary codeword corresponding to at least one Rice parameter associated with a transform residual coding process; and encoding a block of picture information based on the fixed binary codeword.

In general, at least one example of an embodiment can involve apparatus comprising: one or more processors configured to determine a fixed binary codeword corresponding to at least one Rice parameter associated with a transform residual coding process; and encode a block of picture information based on the fixed binary codeword.

In general, at least one example of an embodiment can involve a method comprising: determining at least one Rice parameter associated with a transform residual coding process applied during coding of a block of picture information, wherein the at least one Rice parameter is determined based on at least one frequency region or a coefficient scanning position for the transform residual coding; and decoding the block of picture information based on the at least one Rice parameter.

In general, at least one example of an embodiment can involve apparatus comprising: one or more processors configured to determine at least one Rice parameter associated with a transform residual coding process applied during coding of a block of picture information, wherein the at least one Rice parameter is determined based on at least one frequency region or a coefficient scanning position for the transform residual coding; and decode the block of picture information based on the at least one Rice parameter.

In general, at least one example of an embodiment can involve a method comprising: determining at least one Rice parameter associated with a transform residual coding process, wherein the at least one Rice parameter is determined based on at least one frequency region or a coefficient scanning position for the transform residual coding; and encoding a block of picture information based on the at least one Rice parameter.

In general, at least one example of an embodiment can involve apparatus comprising: one or more processors configured to determine at least one Rice parameter associated with a transform residual coding process, wherein the at least one Rice parameter is determined based on at least one frequency region or a coefficient scanning position for the transform residual coding; and encode a block of picture information based on the at least one Rice parameter.

In general, at least one example of an embodiment can involve a method comprising: determining at least one Rice parameter associated with a transform residual coding process applied during coding of a block of picture information, wherein the at least one Rice parameter is determined based on a number of neighbors of the block of picture information less than five; and decoding the block of picture information based on the at least one Rice parameter.

In general, at least one example of an embodiment can involve apparatus comprising: one or more processors configured to determine at least one Rice parameter associated with a transform residual coding process applied during coding of a block of picture information, wherein the at least one Rice parameter is determined based on a number of neighbors of the block of picture information less than five; and decode the block of picture information based on the at least one Rice parameter.

In general, at least one example of an embodiment can involve a method comprising: determining at least one Rice parameter associated with a transform residual coding process, wherein the at least one Rice parameter is determined based on a number of neighbors of the block of picture information less than five; and encoding the block of picture information based on the at least one Rice parameter.

In general, at least one example of an embodiment can involve apparatus comprising: one or more processors configured to determine at least one Rice parameter associated with a transform residual coding process, wherein the at least one Rice parameter is determined based on a number of neighbors of the block of picture information less than five; and encode the block of picture information based on the at least one Rice parameter.

In general, at least one example of an embodiment can involve method comprising: determining at least one Rice parameter associated with a transform residual coding process applied during coding of a block of picture information, wherein determining the at least one Rice parameter is based on one of: determining a fixed binary codeword corresponding to the at least one Rice parameter; or at least one frequency region or a coefficient scanning position for the transform residual coding; or a number of neighbors of the block of picture information less than five; and decoding the block of picture information based on the at least one Rice parameter.

In general, at least one example of an embodiment can involve apparatus comprising: one or more processors configured to determine at least one Rice parameter associated with a transform residual coding process applied during coding of a block of picture information, wherein determining the at least one Rice parameter is based on one of: determining a fixed binary codeword corresponding to the at least one Rice parameter; or at least one frequency region or a coefficient scanning position for the transform residual coding; or a number of neighbors of the block of picture information less than five; and decode the block of picture information based on the at least one Rice parameter.

In general, at least one example of an embodiment can involve a method comprising: determining at least one Rice parameter associated with a transform residual coding process, wherein determining the at least one Rice parameter is based on one of: determining a fixed binary codeword corresponding to the at least one Rice parameter; or at least one frequency region or a coefficient scanning position for the transform residual coding; or a number of neighbors of the block of picture information less than five; and encoding the block of picture information based on the at least one Rice parameter.

In general, at least one example of an embodiment can involve apparatus comprising: one or more processors configured to determine at least one Rice parameter associated with a transform residual coding process, wherein determining the at least one Rice parameter is based on one of: determining a fixed binary codeword corresponding to the at least one Rice parameter; or at least one frequency region or a coefficient scanning position for the transform residual coding; or a number of neighbors of the block of picture information less than five; and encode the block of picture information based on the at least one Rice parameter.

In general, another example of an embodiment can involve a bitstream or signal formatted to include syntax elements and picture information, wherein the syntax elements are produced and the picture information is encoded by processing based on any one or more of the examples of embodiments of methods in accordance with the present disclosure.

In general, one or more other examples of embodiments can also provide a computer readable storage medium, e.g., a non-volatile computer readable storage medium, having stored thereon instructions for encoding or decoding picture information such as video data according to the methods or the apparatus described herein. One or more embodiments can also provide a computer readable storage medium having stored thereon a bitstream generated according to methods or apparatus described herein. One or more embodiments can also provide methods and apparatus for transmitting or receiving a bitstream or signal generated according to methods or apparatus described herein.

Various implementations involve decoding. “Decoding”, as used in this application, can encompass all or part of the processes performed, for example, on a received encoded sequence in order to produce a final output suitable for display. In various embodiments, such processes include one or more of the processes typically performed by a decoder, for example, entropy decoding, inverse quantization, inverse transformation, and differential decoding. In various embodiments, such processes also, or alternatively, include processes performed by a decoder of various implementations described in this application.

As further examples, in one embodiment “decoding” refers only to entropy decoding, in another embodiment “decoding” refers only to differential decoding, and in another embodiment “decoding” refers to a combination of entropy decoding and differential decoding. Whether the phrase “decoding process” is intended to refer specifically to a subset of operations or generally to the broader decoding process will be clear based on the context of the specific descriptions and is believed to be well understood by those skilled in the art.

Various implementations involve encoding. In an analogous way to the above discussion about “decoding”, “encoding” as used in this application can encompass all or part of the processes performed, for example, on an input video sequence in order to produce an encoded bitstream. In various embodiments, such processes include one or more of the processes typically performed by an encoder, for example, partitioning, differential encoding, transformation, quantization, and entropy encoding.

As further examples, in one embodiment “encoding” refers only to entropy encoding, in another embodiment “encoding” refers only to differential encoding, and in another embodiment “encoding” refers to a combination of differential encoding and entropy encoding. Whether the phrase “encoding process” is intended to refer specifically to a subset of operations or generally to the broader encoding process will be clear based on the context of the specific descriptions and is believed to be well understood by those skilled in the art.

Note that the syntax elements as used herein are descriptive terms. As such, they do not preclude the use of other syntax element names.

When a figure is presented as a flow diagram, it should be understood that it also provides a block diagram of a corresponding apparatus. Similarly, when a figure is presented as a block diagram, it should be understood that it also provides a flow diagram of a corresponding method/process.

In general, the examples of embodiments, implementations, features, etc., described herein can be implemented in, for example, a method or a process, an apparatus, a software program, a data stream, or a signal. Even if only discussed in the context of a single form of implementation (for example, discussed only as a method), the implementation of features discussed can also be implemented in other forms (for example, an apparatus or program). An apparatus can be implemented in, for example, appropriate hardware, software, and firmware. One or more examples of methods can be implemented in, for example, a processor, which refers to processing devices in general, including, for example, a computer, a microprocessor, an integrated circuit, or a programmable logic device. Processors also include communication devices, such as, for example, computers, cell phones, portable/personal digital assistants (“PDAs”), and other devices that facilitate communication of information between end-users. Also, use of the term “processor” herein is intended to broadly encompass various configurations of one processor or more than one processor.

Reference to “one embodiment” or “an embodiment” or “one implementation” or “an implementation”, as well as other variations thereof, means that a particular feature, structure, characteristic, and so forth described in connection with the embodiment is included in at least one embodiment. Thus, the appearances of the phrase “in one embodiment” or “in an embodiment” or “in one implementation” or “in an implementation”, as well any other variations, appearing in various places throughout this application are not necessarily all referring to the same embodiment.

Additionally, this application may refer to “determining” various pieces of information. Determining the information can include one or more of, for example, estimating the information, calculating the information, predicting the information, or retrieving the information from memory.

Further, this application may refer to “accessing” various pieces of information. Accessing the information can include one or more of, for example, receiving the information, retrieving the information (for example, from memory), storing the information, moving the information, copying the information, calculating the information, determining the information, predicting the information, or estimating the information.

Additionally, this application may refer to “receiving” various pieces of information. Receiving is, as with “accessing”, intended to be a broad term. Receiving the information can include one or more of, for example, accessing the information, or retrieving the information (for example, from memory). Further, “receiving” is typically involved, in one way or another, during operations such as, for example, storing the information, processing the information, transmitting the information, moving the information, copying the information, erasing the information, calculating the information, determining the information, predicting the information, or estimating the information.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as is clear to one of ordinary skill in this and related arts, for as many items as are listed.

As will be evident to one of ordinary skill in the art, implementations can produce a variety of signals formatted to carry information that can be, for example, stored or transmitted. The information can include, for example, instructions for performing a method, or data produced by one of the described implementations. For example, a signal can be formatted to carry the bitstream of a described embodiment. Such a signal can be formatted, for example, as an electromagnetic wave (for example, using a radio frequency portion of spectrum) or as a baseband signal. The formatting can include, for example, encoding a data stream and modulating a carrier with the encoded data stream. The information that the signal carries can be, for example, analog or digital information. The signal can be transmitted over a variety of different wired or wireless links, as is known. The signal can be stored on a processor-readable medium.

Various embodiments are described herein. Features of these embodiments can be provided alone or in any combination, across various claim categories and types. Further, embodiments can include one or more of the following features, devices, or aspects, alone or in any combination, across various claim categories and types:

providing for video encoding and/or decoding comprising transform residual coding/decoding based on reducing the neighboring dependencies for Rice parameter derivation;
providing for video encoding and/or decoding comprising transform residual coding/decoding based on reducing the neighboring dependencies for Rice parameter derivation, thereby providing for increased throughput;
providing for video encoding and/or decoding comprising transform residual coding/decoding based on selecting a local neighboring template including a number of neighbors less than a value to be used for Rice parameter derivation process to obtain parameters;
providing for video encoding and/or decoding comprising transform residual coding/decoding including selecting a local neighboring template based on a number of neighbors less than a value, wherein the template is to be used for Rice parameter derivation process to obtain parameters, and wherein the parameters used for syntax abs_remainder and syntax dec_abs_level;
providing for video encoding and/or decoding comprising transform residual coding/decoding based on reducing the number of neighbors in a local neighboring template in Rice parameter derivation;
providing for video encoding and/or decoding comprising transform residual coding/decoding based on a number of neighbors used in the local neighboring template being any value less than a particular value;
providing for video encoding and/or decoding comprising transform residual coding/decoding based on a number of neighbors used in a local neighboring template being less than a particular value, wherein the particular value equals five;
providing for video encoding and/or decoding comprising transform residual coding/decoding based on a number of neighbors used in a local neighboring template in Rice parameter derivation being less than a particular value, wherein the particular value of the number of neighbors used in a local neighboring template is different for derivation of each of a first parameter and a second parameter, e.g., a parameter for syntax abs_remainder and a parameter for syntax dec_abs_level, respectively;
providing for video encoding and/or decoding comprising transform residual coding/decoding based on a number of neighbors used in a local neighboring template in Rice parameter derivation being less than a particular value, wherein the number of neighbors used in a local neighboring template is different for derivation of each of a first parameter and a second parameter, e.g., a parameter for syntax abs_remainder and a parameter for syntax dec_abs_level, respectively, and wherein the particular value is five;
providing for video encoding and/or decoding comprising transform residual coding/decoding based on removing the neighboring dependencies, wherein doing so can provide increased throughput;
providing for video encoding and/or decoding comprising transform residual coding/decoding based on a fixed Rice parameter (e.g. cRiceParam equal to k) for first and second parameters, e.g., a parameter for syntax abs_remainder and a parameter for syntax dec_abs_level;
providing for video encoding and/or decoding comprising transform residual coding/decoding based on the Rice parameter k can be unified with that for transform skip (TS) residual coding;
providing for video encoding and/or decoding comprising transform residual coding/decoding based on the Rice parameter k being set as 1 and unified with the TS residual coding;
providing for video encoding and/or decoding comprising transform residual coding/decoding and TS residual coding/decoding, wherein the Rice parameter k could be fixed and set as any same value, thereby providing for unification of the transform residual coding and the TS residual coding;
providing for video encoding and/or decoding comprising transform residual coding/decoding, wherein the Rice parameter k could be fixed and set as different values for each of first and second parameters, e.g., a parameter for syntax abs_remainder and a parameter for syntax dec_abs_level;
providing for video encoding and/or decoding comprising transform residual coding/decoding including removing the neighboring dependencies for high throughput while keeping the per-sample codeword adaptively binarized for better coding efficiency;
providing for video encoding and/or decoding comprising transform residual coding/decoding including deriving the Rice parameter for at least one parameter, e.g., a parameter for syntax abs_remainder and a parameter for syntax dec_abs_level, based on the frequency region or the coefficient scanning position;
providing for video encoding and/or decoding comprising transform residual coding/decoding including deciding the Rice parameter k by comparing diagonal position of the coefficient with a particular value or values, e.g., predefined values or thresholds;
providing for video encoding and/or decoding comprising transform residual coding/decoding including deriving the Rice parameter for the abs_remainder and dec_abs_level based on the frequency region or the coefficient scanning position and including setting the number of frequency regions and/or the number of Rice parameters to any value;
providing for video encoding and/or decoding comprising transform residual coding/decoding including deriving the Rice parameter for the abs_remainder and dec_abs_level based on the frequency region, wherein the Rice parameter k could be assigned with one frequency region;
providing for video encoding and/or decoding comprising transform residual coding/decoding including deriving the Rice parameter for the abs_remainder and dec_abs_level based on the frequency region, and further including sharing the same Rice parameter k among one or more frequency regions;
providing for video encoding and/or decoding comprising transform residual coding/decoding including deriving the Rice parameters, wherein the set of Rice parameter values could be different for luma and chroma components;
providing for video encoding and/or decoding comprising transform residual coding/decoding including deriving the Rice parameter for the abs_remainder and dec_abs_level based on the frequency region, wherein the frequency regions splitting implementation, e.g., logic, could be different for luma and chroma components;
providing for video encoding and/or decoding comprising transform residual coding/decoding including deriving the Rice parameter for the abs_remainder and dec_abs_level based on the frequency region, wherein the frequency regions splitting implementation, e.g., logic, could be different for each of a first parameter and a second parameter, e.g., a parameter for syntax abs_remainder and a parameter for syntax dec_abs_level, respectively;
providing for video encoding and/or decoding comprising transform residual coding/decoding including deriving the Rice parameter for the abs_remainder and dec_abs_level based on the frequency region, deciding the Rice parameter k based on comparing the scanning position of the coefficient with other logics;
providing in an encoder and/or decoder for transform residual coding/decoding in accordance with any of the embodiments, features or entities, alone or in any combination, as described herein based on providing reduced complexity and/or improved compression efficiency;
providing for a bitstream or signal that includes one or more of the described syntax elements, or variations thereof;
providing for a bitstream or signal that includes syntax conveying information generated according to any of the embodiments described;
providing for inserting in the signaling syntax elements that enable the decoder to operate in a manner corresponding to that used by an encoder;
inserting in the signaling syntax elements that enable the encoder and/or decoder to provide encoding and/or decoding in accordance with any of the embodiments, features or entities, alone or in any combination, as described herein.
selecting, based on these syntax elements, the features or entities, alone or in any combination, as described herein to apply at the decoder;
providing for creating and/or transmitting and/or receiving and/or decoding a bitstream or signal that includes one or more of the described syntax elements, or variations thereof;
providing for creating and/or transmitting and/or receiving and/or decoding a bitstream according to any of the embodiments described;
a method, process, apparatus, medium storing instructions, medium storing data, or signal according to any of the embodiments described;
a TV, set-top box, cell phone, tablet, or other electronic device that provides for applying encoding and/or decoding according to any of the embodiments, features or entities, alone or in any combination, as described herein;
a TV, set-top box, cell phone, tablet, or other electronic device that performs encoding and/or decoding according to any of the embodiments, features or entities, alone or in any combination, as described herein, and that displays (e.g. using a monitor, screen, or other type of display) a resulting image;
a TV, set-top box, cell phone, tablet, or other electronic device that tunes (e.g. using a tuner) a channel to receive a signal including an encoded image, and performs encoding and/or decoding according to any of the embodiments, features or entities, alone or in any combination, as described herein;
a TV, set-top box, cell phone, tablet, or other electronic device that receives (e.g. using an antenna) a signal over the air that includes an encoded image, and performs encoding and/or decoding according to any of the embodiments, features or entities, alone or in any combination, as described herein;
a computer program product storing program code that, when executed by a computer encoding and/or decoding in accordance with any of the embodiments, features or entities, alone or in any combination, as described herein.
a non-transitory computer readable medium including executable program instructions causing a computer executing the instructions to implement encoding and/or decoding in accordance with any of the embodiments, features or entities, alone or in any combination, as described herein.

1. A method comprising:
determining a fixed binary codeword corresponding to at least one Rice parameter associated with a transform residual coding process applied during coding of a block of picture information; and
decoding the block of picture information based on the fixed binary codeword.

2-4. (canceled)

5. A method comprising:
determining at least one Rice parameter associated with a transform residual coding process applied during coding of a block of picture information, wherein the at least one Rice parameter is determined based on at least one frequency region or a coefficient scanning position for the transform residual coding; and
decoding the block of picture information based on the at least one Rice parameter.

6. An apparatus comprising:
one or more processors configured to
determine at least one Rice parameter associated with a transform residual coding process applied during coding of a block of picture information, wherein the at least one Rice parameter is determined based on at least one frequency region or a coefficient scanning position for the transform residual coding; and
decode the block of picture information based on the at least one Rice parameter.

7-16. (canceled)

17. The method of claim 1, wherein the at least one Rice parameter is set to 1.

18. The method of claim 1, wherein the at least one Rice parameter comprises first and second Rice parameters.

19. The method of claim 18, wherein the number of neighbors is different for derivation of each of the first Rice parameter and the second Rice parameter.

20. The method of claim 18, wherein the first and second Rice parameters are both fixed parameters.

21. The method of claim 20, wherein the first and second Rice parameters are both set to the same fixed value.

22. (canceled)

23. The method of claim 18, wherein the first and second Rice parameters are set to different fixed values.

24. The method of claim 5, wherein the coefficient scanning position corresponds to a diagonal position of the coefficient, and determining the at least one Rice parameter based on the coefficient scanning position comprises comparing the diagonal position of the coefficient with a particular value or values.

25. The method of claim 5, wherein determining the at least one Rice parameter comprises setting a number of frequency regions to any value.

26. The method of claim 5, wherein determining the at least one Rice parameter comprises assigning the at least one Rice parameter with one frequency region.

27. The method of claim 5, wherein determining the at least one Rice parameter comprises sharing the same Rice parameter among one or more frequency regions.

28. The method of claim 5, wherein the at least one frequency region comprises a number of frequency regions determined based on a different frequency region splitting implementation for luma components and chroma components.

29. The method of claim 28, wherein the at least one frequency region comprises a number of frequency regions determined based on a different frequency region splitting implementation for each of the first Rice parameter and the second Rice parameter.

30. (canceled)

31. (canceled)

32. A non-transitory computer readable medium storing executable program instructions to cause a computer executing the instructions to perform a method according to any of claim 5.

33-36. (canceled)

37. The apparatus of claim 6, wherein the coefficient scanning position corresponds to a diagonal position of the coefficient, and determining the at least one Rice parameter based on the coefficient scanning position comprises comparing the diagonal position of the coefficient with a particular value or values.

38. The apparatus of claim 6, wherein determining the at least one Rice parameter comprises setting a number of Rice parameters to any value.

39. The apparatus of claim 6, wherein determining the at least one Rice parameter comprises assigning the at least one Rice parameter with one frequency region.

40. The apparatus of claim 6, wherein determining the at least one Rice parameter comprises sharing the same Rice parameter among one or more frequency regions.
